(19) United States
(12) Patent Application Publication
(10) Pub. No.: US 2005/0277089 A1
(43) Pub. Date: Dec. 15, 2005

(54) Method and device for producing a carbon-fiber reinforced dental prosthesis

(76) Inventor: Izidor Brajnovic, Goteborg (SE)

Correspondence Address: KNOBBE MARTENS OLSON & BEAR LLP, 2040 MAIN STREET, FOURTEENTH FLOOR, IRVINE, CA, 92614, US

(21) Appl. No.: 11/139,030

(22) Filed: May 26, 2005

Related U.S. Application Data
(63) Continuation of application No. PCT/SE03/01800, filed on Nov. 20, 2003.

(30) Foreign Application Priority Data
Nov. 27, 2002 (SE) NO.: SE 0203497-3

(51) Int. Cl. A61C 13/00

(52) U.S. Cl. 433/167; 433/199.1

(57) ABSTRACT

An arrangement intended for use in the production of a carbon-fiber-reinforced dental prosthesis and comprising an elongate tube substantially following the arch shape of the dental prosthesis. Carbon fiber hoses with carbon fiber wires lie inside the tube. A substance is also arranged in the tube. The substance can be introduced in liquid form in order to surround and wet the carbon fiber material. The substance can harden inside the tube with the aid of heat treatment in order to bind the carbon fiber material together and give rise to a mechanically strong dental bridge bar. The tube is made with an initially curved shape and, before application and hardening of the substance, the carbon fiber material assumes arched shapes which follow the shape of the tube. The carbon fiber material is intended to ensure that the shape of the tube is not affected and can thus be retained with its desired course without kinks and sharp bends. The bar can in this way be arranged optimally in the dental prosthesis.

### PRIORITY INFORMATION

This application is a continuation of International Application PCT/SE2003/001800, with an international filing date of Nov. 20, 2003, published in English and which claims priority under 35 U.S.C. § 119 to Swedish Patent Application No. SE 0203497-3, filed Nov. 27, 2002, the entire contents of both of which are expressly incorporated by reference herein.

### BACKGROUND OF THE INVENTION

1. Field of the Invention

An arrangement intended for use in the production of a carbon-fiber-reinforced dental prosthesis.

2. Description of the Related Art and Summary of the Invention

Reference is made inter alia to Swedish patent 457 691 and Swedish patent application 0004883-5 filed by the same Applicant as the present patent application. this patent and patent application deal with the design and production of carbon fiber bridge bars. Use is made, inter alia, of a latex tube which is provided on the inside with carbon fiber material and in which a two-component plastic material or substance (resin) is injected into a closed arrangement. The tube with the carbon fibers lying inside it is adapted to the actual model or actual tool for production of the actual dental bridge, and the substance is caused to harden so that the carbon fiber bridge bar or unit forming part of the dental bridge assumes the desired shape. The tube is removed in a final stage of the production chain, and the carbon fiber material exposed in this way forms the bar or unit in question.

In this connection, it is advantageous, from the point of view of stability and appearance, that the finished dental bridge bar can be optimally adapted to the shape of the dental bridge or extent of the dental bridge. Thus, for example, there should be no or minimal kinks or sharp corners which might work against a satisfactory or optimal result. An object of an embodiment of the present invention is to solve this problem, among others, and it aims to provide the dental bridge bar or unit with a gentle and curved shape (in the horizontal section of the dental bridge) which follows the extent of the dental bridge in an optimal manner.

It is advantageous that the carbon fiber material and the substance can be applied in the tube in a way which does not pose a hazard to individuals, so that the personnel involved are not exposed to vapors and gases from the substance. In addition, the desired shape should be able to be retained during all the stages of production of the dental bridge. Among other things, the effects on the carbon fiber material caused by the hardening of the substance must not result in the carbon fibers distorting the desired arch shape during hardening of the substance. Embodiments of the present invention also solve this problem.

Another embodiment of the present invention relates to an arrangement intended for use in a method for the production of a carbon-fiber-reinforced dental prosthesis. Use is made of an elongate tube substantially following the arch-shaped course of the dental prosthesis, and carbon fiber hoses arranged in one another in this tube, and carbon fiber wires lying inside these carbon fiber hoses. Use is also made of a substance, for example a two-component plastic, arranged, on the one hand, to be introduced into the tube in liquid form in order to surround and wet the carbon fiber hoses and carbon fiber wires, and, on the other hand, to harden inside the tube with the aid of heat treatment (polymerization) in order to bind the carbon fiber hoses and carbon fiber wires together and thus give rise to a mechanically strong unit or dental bridge bar forming part of the dental prosthesis. In a final stage of the production method, said tube is removed and the unit or dental bridge bar consists of the carbon fiber material held together by said substance.

In one embodiment of the present invention, the tube is made with a curved (arched) shape and that, before application and hardening of the substance, the carbon fiber hoses and carbon fiber wires are made to assume mutual longitudinal displacement positions inside the tube which mean that the tube, with the carbon fiber hoses and carbon wires and the added and hardened substance, substantially retains the curved shape.

In one embodiment of the present invention, the tube is formed in a manner known per se of plastic material, preferably latex, and has a wall thickness in the range of 0.2-0.4 mm. The wall thickness is preferably ca. 0.3 mm. The tube can be given its arched shape with the aid of one or more immersions in a bath of substantially the same type of plastic material, i.e. latex in this embodiment, as the tube is made of, after the tube has been given its arched shape, preferably by means of a tool. It is advantageous here that the arched shape with the carbon fiber material and substance lying inside the tube can be retained during all of the stages of production of the dental bridge bar or corresponding unit. Further embodiments of present invention which concern this and other problems are set out in the attached dependent claims.

By means of what has been proposed above, shape-stable dental bridge bars can be obtained using already existing technology. The novel ideas for dental bridge bar production do not burden production from the economic point of view. By means of the invention, it is possible to give the carbon fiber material the desired or required course inside the tube before wetting and hardening of the substance, which means that the latter does not adversely affect the carbon fiber material and distort the arched or curved shape.

Another embodiment of the present invention comprises arrangement for use in the production of a carbon-fiber-reinforced dental prosthesis. The arrangement includes an elongate tube having an arched shape of the dental prosthesis. A plurality of carbon fiber hoses are arranged alongside one another in with the tube. A plurality of carbon fiber wires lie inside the plurality of carbon fiber hoses. A substance is configured to be introduced into the tube in liquid form to surround and wet the carbon fiber hoses and carbon fiber wires and to harden inside the tube in order to bind the carbon fiber hoses and carbon fiber wires together to form a mechanically strong unit. The tube has the arched shape of the dental prosthesis, before application and hardening of the substance so that the carbon fiber hoses and carbon fiber wires can assume mutual longitudinal displacement positions inside the tube.

Another embodiment of the present invention comprises a method of forming a carbon-fiber reinforced dental prosthesis. In the method, an elongated tubing having an arched shape is provided. Carbon fiber hoses and wires are provided with in the tube. A hardenable substance is injected into the tube. The substance is allowed to harden within the arched tube.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

A presently proposed embodiment of an arrangement having the defining features of the invention will be described below with reference to the attached drawings, in which:

FIG. 1 is a cross-sectional view of a portion of a tube with an arched shape;

FIG. 1a shows, in a diagrammatic vertical view, how a desired arched shape is obtained for a tube which is to be provided with said carbon fiber material and substance, the figure also showing a tool for arching the tube in question during immersion in a bath;

FIG. 2 shows, in a vertical view, application of substance in a latex tube provided with carbon fibers;

FIG. 3 shows a perspective view, obliquely from above, of the latex tube with carbon fiber and substance applied on perforating pins in a tool;

FIG. 4 shows a perspective view, obliquely from above, of the position of the tube, with carbon fibers lying inside, on cylinders with the aid of an assembly tool;

FIG. 5 shows, in a perspective view obliquely from above, the tube with carbon fiber material and a substance lying inside it, upon fitting of the carbon fiber bridge bar and tooth retention;

FIG. 6 shows a perspective view, obliquely from above, of polymerization in an oven;

FIG. 7 shows a perspective view of the removal of the latex tube from the dental bridge bar thus finished; and

FIG. 7a shows a diagrammatic perspective view of parts of a dental bridge with dental bridge bar lying inside it.

### DETAILED DESCRIPTION OF THE PREFERRED EMBODIMENTS

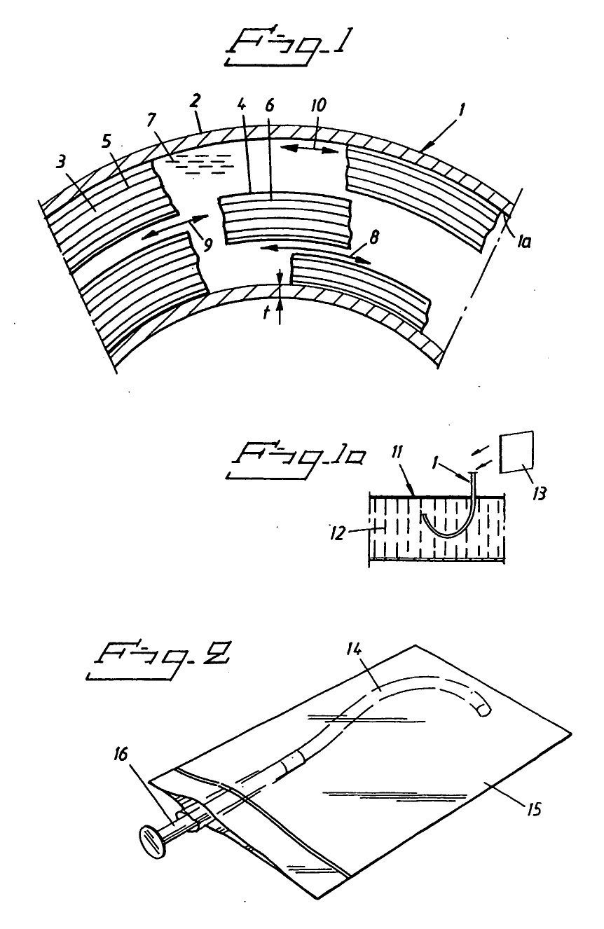

FIG. 1 illustrates parts of a latex tube 1. The tube 1 has a wall thickness of ca. 0.3 mm and can be chosen with a wall thickness range of 0.2-0.4 mm. In accordance an embodiment of the invention, the tube 1 is to be formed with an arched or curved shape 2, preferably, with no sharp kinks and bends. A number of carbon fiber hoses 3, 4 are arranged inside the tube 1, and, in one illustrative embodiment, the tube 1 can enclose four carbon fiber hoses 3, 4 inserted one into the other. In FIG. 1, two hoses 3, 4 are indicated symbolically by reference numbers 3 and 4. Carbon fiber wires are arranged inside the hoses 3, 4. Both the hoses 3, 4 and the carbon fiber wires are already known, and reference is made inter alia to the patent publications cited above.

A substance partly depicted and indicated by reference number 7 has also been applied in the tube 1. The purpose of the substance 7 is to wet said hoses 3,4 and wires, i.e. the carbon fiber material. The substance is also intended to be able to assume a hardened form and bind the hoses or carbon fiber materials to one another. A preferred characteristic of said hoses 3, 4 and carbon fiber wires is that they are given their longitudinal displacement positions before the wetting and hardening of the substance 7. In this way, the hoses 3, 4 and the wires can execute longitudinal displacement movements in connection with application when the tube 1 is filled with the carbon fiber material. The longitudinal displacement means that the carbon fiber material can assume arched positions without stresses occurring in the carbon fiber material during said wetting and hardening of the material. The mutual longitudinal displacement movements between the carbon fiber material and the carbon fiber material and the inner surface 1a of the tube are symbolized by 8, 9 and 10.

Production of a latex tube in accordance with the above is already known per se and is not part of the present invention, for which reason it will not be described in detail here. By contrast, the initial stage of the production of the dental bridge bar or unit is a part of an embodiment of the present invention. The curved shape of the tube 1 is shown in FIG. 1a. The desired arched starting shape can be obtained in a manner known per se by immersing a straight tube in a bath 2 comprising a substance 12 which corresponds with or is compatible with the material of the tube, i.e. in this case latex. The arched shape in connection with the immersion in the bath 3 can be obtained, likewise in a manner known per se, by means of a indicated symbolically by 11 in FIG. 1a. The configuration and function of the tool do not concern the invention, but reference is made to the prior art.

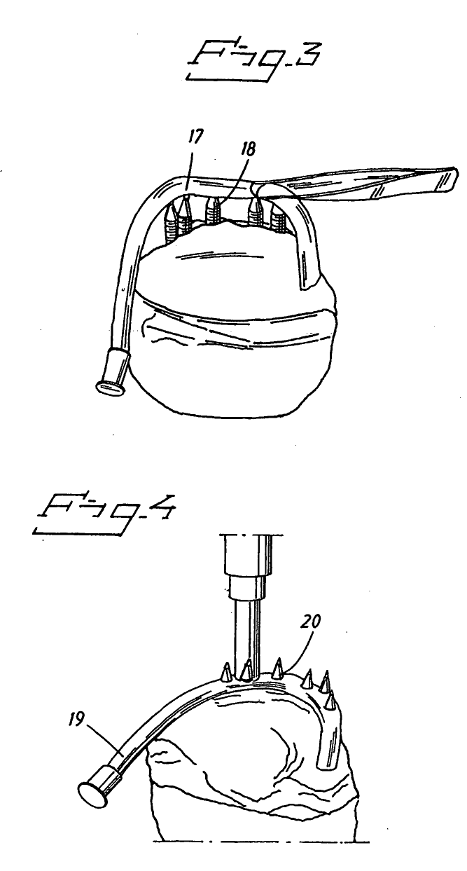

In FIG. 2, a tube which has been arched in this way is indicated by 14. In the case or the stage according to FIG. 2, the 14 tube has been provided internally with carbon fiber hoses and carbon fiber wires according to FIG. 1. In the stage according to FIG. 2, the carbon fiber material in the tube 14 must be wetted in a way which does not pose a hazard to personnel. For this reason, the tube 14 is applied in a manner known per se in a plastic bag 15 which prevents escape of vapors or gases from the substance (cf. 7 in FIG. 1). The substance is introduced into the tube likewise in a known manner using an injection syringe 16. FIG. 2 is intended to show that, during and after application of the substance, the tube assumes its arched original shape which has been obtained in the procedure according to FIG. 1a.

In the case or the stage according to FIG. 3, the carbon fiber assembly lying inside the tube and exposed to wetting is to be pierced through by piercing through with perforating pins. This piercing as such is already known per se, and in the case shown in FIG. 3 the carbon fiber assembly can be applied and pierced through without the carbon fiber assembly having to be bent, since the initially allocated arched shape is used.

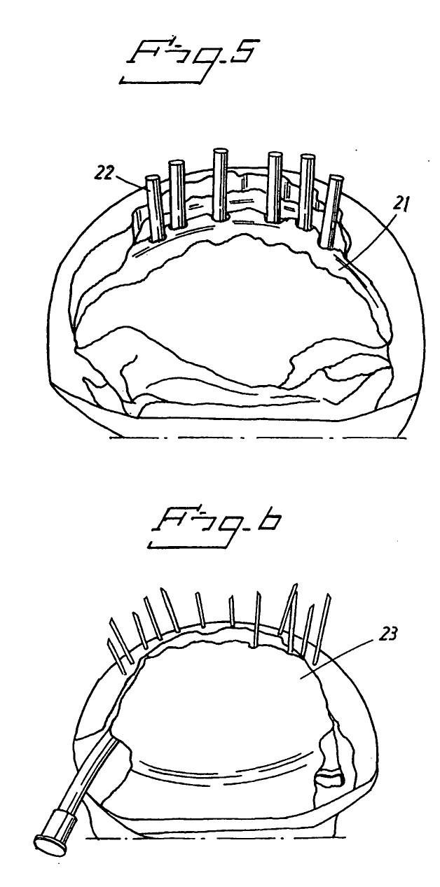

In the next stage too according to FIG. 4, the tube and the carbon fiber assembly can be placed around used cylinders 20 which are applied under said perforating pins according to FIG. 3. The application can be carried out without further affecting the arched shape of the assembly in accordance with the above.

The stage shown in FIG. 5 concerns fitting of the carbon fiber bridge bar and tooth retentions. The bar or unit is in this case indicated by 21 and the tooth retentions are symbolized by 22. In this case too, the tube 21 can maintain its original arch, which makes fitting easier.

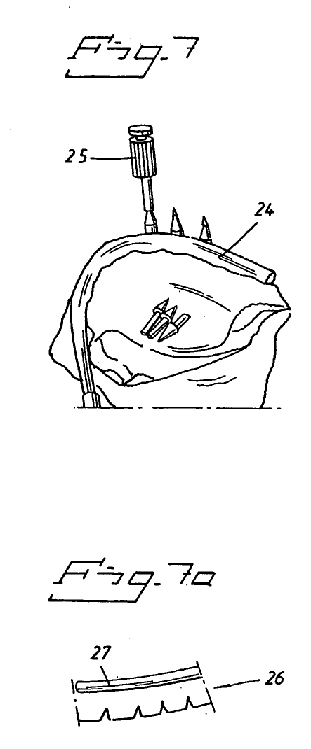

FIG. 6 shows the case where the carbon fiber bar has been embedded with the aid of silicone castings and the bar can in this way be polymerized in an oven in a manner known per se. The silicone castings are symbolized by 23 and the polymerization in the oven can be carried out at, for example, 70° for two hours.

FIG. 7 shows the removal of the silicone castings and the latex tube. The exposed carbon fiber material with the hardened substance or the two-component plastic thus forms, after removal of the latex tube, a dental bridge bar or unit which can be used in a manner known per se in a carbon-fiber-reinforced bridge.

FIG. 7a is a diagram showing parts of a dental bridge construction 26 comprising a dental bridge bar 27 according to the invention.

The invention is not limited to the embodiment described above by way of example, and instead it can be modified within the scope of the attached patent claims and the inventive concept. Moreover, although the foregoing systems and methods have been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. While certain embodiments of the inventions have been described, these embodiments have been presented by way of example only, and are not intended to limit the scope of the inventions. Indeed, the novel methods and systems described herein may be embodied in a variety of other forms without departing from the spirit thereof.

1. An arrangement for use in the production of a carbon-fiber-reinforced dental prosthesis, comprising
an elongate tube having an arched shape of the dental prosthesis;
a plurality of carbon fiber hoses arranged alongside one another in with the tube;
a plurality of carbon fiber wires lying inside the plurality of carbon fiber hoses;
a substance configured to be introduced into the tube in liquid form to surround and wet the carbon fiber hoses and carbon fiber wires and to harden inside the tube in order to bind the carbon fiber hoses and carbon fiber wires together to form a mechanically strong unit.
wherein the tube has the arched shape of the dental prosthesis, before application and hardening of the substance so that the carbon fiber hoses and carbon fiber wires can assume mutual longitudinal displacement positions inside the tube.

2. The arrangement as in claim 1, wherein the tube comprises a plastic material.

3. The arrangement as in claim 1, wherein the tube comprises latex.

4. The arrangement as in claim 1, wherein the tube has a wall thickness (t) in the range of 0.2-0.4 mm.

5. The arrangement as in claim 1, wherein the tube is given its arched shape by at least one immersions in a bath of substantially the same type of material as the tube is made of.

6. The arrangement as in claim 5, wherein the carbon fiber hoses and carbon fiber wires lying inside the tube can be brought to their positions in the tube after the tube has been given its arched shape, and in that, upon application of the carbon fiber hoses and carbon fiber wires in the tube, said longitudinal displacement positions can be given to the hoses and wires.

7. The arrangement as in claim 1, wherein in the arched shape of the tube has substantially no kinks or sharp corners.

8. The arrangement as claim 1, wherein in that the tube is configured such that it can be engaged on tooth retentions in connection with fitting the arrangement which is to form a carbon fiber bridge bar.

9. The arrangement as in claim 1, wherein the tube with cable hoses, carbon fiber wires and the substance situated inside are configured such that they can be pierced by perforating pins while at the same time retaining the arched shape.

10. The arrangement as in claim 1, wherein the tube with carbon fiber hoses, carbon fiber wires and the substance situated inside are configured such that they can be applied in an assembly tool while retaining the curved shape.

11. The arrangement as in claim 1, wherein the tube with the carbon fiber hoses, carbon fiber wires and the substance lying inside it are configured to retain the curved shape after polymerization in an oven.

12. The arrangement as in claim 1, wherein the polymerization in the over is done at 70° C. for about 2 hours.

13. The arrangement as in claim 1, wherein the tube is configured to be able to be removed on completion of a hardening process while at the same time retaining the curved shape for the carbon fiber hoses and carbon fiber wires.

14. The arrangement as claim 1, wherein the carbon fiber hoses, because of their positions in the tube, are prevented from affecting the desired arch shape during the wetting and hardening of the substance.

15. The arrangement of claim 1, wherein the substance comprises a two-component plastic.

16. The arrangement of claim 1, wherein substance hardens in response to heat treatment.

17. A method of forming a carbon-fiber reinforced dental prosthesis, the method comprising:
providing an elongated tubing having an arched shape;
providing carbon fiber hoses and wires with in the tube;
injecting a hardenable substance into the tube; and
allowing the substance to harden within the arched tube.

18. The method of claim 17, further comprising piercing the tube with perforating pins.

19. The method of claim 17, further comprising hardening the substance within an oven.

20. The method of claim 17, further comprising placing the tube within a silicone casting.
